(19) United States
(12) Patent Application Publication
(10) Pub. No.: US 2008/0206444 A1
(43) Pub. Date: Aug. 28, 2008

(54) Film-Forming Product, Film-Forming Method and Mold Release Agent

(76) Inventors: Takeshi Matsuo, Kanagawa-Ken (JP); Mitsuo Suzuki, Kanagawa-Ken (JP); Takaaki Niinomi, Kanagawa-Ken (JP)

Correspondence Address: NIXON & VANDERHYE, PC, 901 NORTH GLEBE ROAD, 11TH FLOOR, ARLINGTON, VA, 22203, US

(21) Appl. No.: 11/659,707

(22) PCT Filed: Aug. 4, 2005
(86) PCT No.: PCT/JP2005/014309

§ 371 Date: Dec. 21, 2007

(30) Foreign Application Priority Data
Aug. 16, 2004 (JP) 2004-236715

(51) Int. Cl. C23C 26/00; C09D 1/00

(52) U.S. Cl. 427/11; 106/38.28; 977/734

(57) ABSTRACT

There is provided a film-forming product used for forming a film containing fullerenes as a main component. The film containing fullerenes as a main component may be used as a mold release agent and a lubricant as well as a colorant, a writing utensil, cosmetics and a mending material. The present invention relates to a film-forming product constituted of a molded product containing fullerenes as a main component. In the preferred embodiment of the present invention, the film-forming product has a bar shape, and used for forming a mold releasing film or a lubricating film.

### TECHNICAL FIELD

The present invention relates to a film-forming product, a film-forming method and a mold release agent, and more particularly, to a film-forming product used for forming a film mainly comprising fullerenes, a method of forming the film, and a mold release agent containing fullerenes.

### BACKGROUND ART

Fullerenes are in the form of a molecular crystal made of carbon solely whose molecule is of a spherical shape or a Rugby ball shape having a size of about 1 nm, and are expected to exhibit a good lubricating performance.

Meanwhile, it is conventionally known that a film of the fullerenes is formed by a vacuum deposition method. However, the vacuum deposition method requires a special vacuum equipment, thereby failing to provide a simple film-forming method. On the other hand, although a spin-coating method is a relatively simple film-forming method, this method is hardly applicable to formation of a film made of fullerenes at the present time owing to the lack of an adequate solvent therefor.

Therefore, notwithstanding the fullerenes are expected to show a lubricating performance, the fullerenes have not been presently used in an industrial scale owing to difficulty in forming a film thereof.

Meanwhile, lines drawn by a pencil are formed by rubbing a surface of a paper with a lead of the pencil. The obtained line drawing is considered to be a film made of the pencil lead material in a broad sense. Conventionally, there has been proposed a baked pencil lead containing fullerenes which is a high-temperature heat-treated type pencil lead using an inorganic filler (for example, refer to Japanese Patent No. 3373302).

The above proposal is based on such a finding that the baked pencil lead can be improved in smoothness by adding fullerenes thereto. However, the amount of the fullerenes added is as small as not more than 0.1% by weight on the basis of the total amount of the based pencil lead. Therefore, the line drawing formed by the baked pencil lead is not considered to be a film substantially made of fullerenes.

### DISCLOSURE OF THE INVENTION

### Problem to be Solved by the Invention

The present invention has been made in view of the above conventional problems. An object of the present invention is to provide a film-forming product used for forming a film containing fullerenes as a main component as well as a method of forming the film. Another object of the present invention is to provide a novel mold release agent.

### Means for Solving Problems

As a result of the present inventors' earnest study, it has been found that fullerenes are readily molded by themselves, and the resultant molded product has a strength sufficient to form a film made of fullerenes when rubbing a surface of an object therewith to attach it thereon, and further that the fullerenes exhibit an excellent releasing performance. The present invention has been attained on the basis of the above finding. The aspects of the present invention are as follows.

That is, in a first aspect of the present invention, there is provided a film-forming product comprising a molded product containing fullerenes as a main component. In a second aspect of the present invention, there is provided a method of forming a film which comprises the step of rubbing a surface of an object with the above film-forming product to attach it thereon. In a third aspect of the present invention, there is provided a mold release agent comprising fullerenes.

### Effect of the Invention

In accordance with the present invention, there is provided a film-forming product used for forming a film containing fullerenes as a main component which may be applicable to a releasing agent and a lubricant as well as a colorant, a writing utensil, cosmetics and a mending material. Further, according to the present invention, there is provided a novel mold release agent.

### BRIEF DESCRIPTION OF THE DRAWINGS

FIG. 1 is a microphotograph as a drawing showing a surface of a coating film formed in Example 3.

FIG. 2 is a microphotograph as a drawing showing a surface of a coating film formed in Comparative Example 2.

### PREFERRED EMBODIMENTS FOR CARRYING OUT THE INVENTION

The present invention is described in detail below. The following preferred embodiments of the present invention are only illustrative and not intended to limit the scope of the present invention. Various changes and modifications will be made unless departing from the subject matter of the present invention.

First, the fullerenes used in the present invention are explained. The “fullerenes” used herein mean those substances having a fullerene skeleton, and include not only fullerene but also fullerene derivatives. In particular, among these substances, from the standpoints of good releasability and lubricating property, preferred is fullerene having a low bulkiness. However, fullerene polymers having a large size whose fullerene skeleton is partially damaged are excluded from the fullerenes used in the present invention. The fullerene is a carbon cluster having a closed shell structure. The number of carbon atoms contained in the fullerene is an even number of usually 60 to 130. Specific examples of the fullerenes may include C₆₀, C₇₀, C₇₆, C₇₈, C₈₂, C₈₄, C₉₀, C₉₄, C₉₆ and higher-order carbon clusters containing a larger number of carbon atoms. Examples of the fullerene derivatives may include those fullerenes containing substituent groups bonded to the fullerene skeleton, those fullerenes containing metal atoms or compounds enclosed in the fullerene skeleton, and complexes of fullerene with other metal atoms or compounds. The substituent groups, metal atoms and compounds contained in the fullerene derivatives are not particularly limited unless they adversely affect the excellent effects of the film-forming product according to the present invention. From the standpoints of good releasability and lubricating property, the substituent groups, metal atoms and compounds preferably have a low bulkiness, and are more preferably those capable of improving a releasability and a lubricating property of the resultant film-forming product. In the present invention, the fullerene skeleton contained in the fullerenes is preferably a C₆₀ skeleton which is readily produced and has a shape close to a sphere. When using a mixture of different kinds of fullerenes, the content of the C₆₀ skeleton in the mixture is preferably not less than 50% by weight, and the content of the C₇₀ skeleton in the mixture is preferably not more than 30% by weight.

Next, the film-forming product of the present invention is described. The film-forming product of the present invention is constituted of a molded product containing fullerenes as a main component.

The content of the fullerenes based on the total amount of the film-forming product is not particularly limited as long as the obtained film-forming product can exhibit excellent effects aimed by the present invention. The content of the fullerenes in the film-forming product is preferably as large as possible. More specifically, the content of the fullerenes in the film-forming product is usually not less than 30% by weight, preferably not less than 50% by weight, more preferably not less than 80% by weight and still more preferably not less than 90% by weight. Further, the film-forming product may be produced such that the content of the fullerenes therein is 100% by weight. When the content of the fullerenes in the film-forming product is too small, a film formed by using the film-forming product tends to contain a too large amount of substances other than the fullerenes, thereby failing to exhibit a sufficient performance of the fullerenes such as a good lubricating property. As the molding raw materials other than the fullerenes, there may be used molding assistants such as the below-mentioned binders.

The shape of the molded product is not particularly limited unless the excellent effects of the film-forming product of the present invention are damaged to a considerable extent. Examples of the shape of the molded product may include a bar shape, a spherical shape, a conical shape, a pyramidal shape, and various other shapes such as an amorphous shape having irregularities with which the product is easily graspable. Among these shapes, the bar shape is preferable from the standpoint of good followability even to irregularities on an object upon forming a film thereon by rubbing a surface of the object with the film-forming product to attach it thereon. The sectional shape of the bar-shaped molded product is not particularly limited, and may include, for example, a circular shape, a triangular shape, a rectangular shape, a hexagonal shape, etc. The bar-shaped molded product usually has a diameter of 0.1 to 10 mm, a length of 10 to 500 mm and an aspect ratio of 1 to 1000. In order to enhance a workability upon forming a film by rubbing a surface of the object with the film-forming product to attach it thereon and protect a peripheral portion of the product, the film-forming product may be covered or sheathed with wood, paper, plastics, etc., for example, except for a part of a tip end portion thereof. Further, the molded product may be formed, for example, into a pencil lead shape, and fitted into a device such as a propelling pencil to allow the product to be used as a writing utensil. As the film-forming method, there may be used the method of rubbing a surface of the object with the molded product of the present invention to attach it thereon, which is fitted to a tip of a high-speed rotating electric jig.

As the molding method for obtaining the above molded product and conditions thereof, there may be used any suitable molding methods and conditions as long as the film-forming product of the present invention can be produced thereby. Examples of the molding method may include various molding methods such as a compression-molding method, an extrusion-molding method and an injection-molding method. The molding pressure used in the molding method is usually 0.005 to 10 ton/cm² and preferably 0.1 to 10 ton/cm²; and the molding (pressing) time used therein is usually 1 to 5 min. When the molding pressure is too high or the molding time is too long, the fullerene skeleton tends to be broken. When the molding pressure is too low or the molding time is too short, the molding method may fail to be sufficiently performed. The atmosphere used upon pressing is such an atmosphere in which the fullerene skeleton is free from breakage due to reaction of the fullerenes, and an atmospheric air is usually sufficient for obtaining the molded product. Also, if required, the molding procedure may be conducted under heating or evacuation.

In addition, upon the molding, in order to enhance a moldability and a stability of the obtained molded product, the molding raw material may be uniformly blended with a molding assistant, a binder, a lubricant and a filler.

Examples of the molding assistant may include polyvinyl alcohol, synthetic waxes, liquid paraffins, animal fats and oils, synthetic resins, waxes, talc, waxes, glues, etc.

Examples of the binder may include cellulose derivatives such as nitrocellulose (pyroxylin), ethyl cellulose, methyl cellulose, cellulose acetate, carboxymethyl cellulose and hydroxyethyl cellulose; thermoplastic resins such as polystyrene, polyethylene, polypropylene, polybutene, polybutadiene, polymethylpentene, polystyrene butadiene, polyvinyl chloride, polyvinyl acetate, polymethyl acrylate, polymethyl methacrylate, polyvinylidene chloride, polytetrafluoroethylene, acryl-styrene resins, acrylonitrile-butadiene-styrene resins, ethylene-tetrafluoroethylene copolymers, polyethylene glycol, polypropylene glycol, polyacrylamide, polyacrylic acid, polyvinyl alcohol, polyvinyl pyrrolidone, polyvinyl ether, maleic acid polymers, polyester polyol resins, polyester polyether resins, polyethylene terephthalate and polybutylene terephthalate; thermosetting resins such as phenol resins and epoxy resins; natural rubbers; and synthetic rubbers such as SBR. These binders may be used in combination of any two or more thereof.

Examples of the lubricant may include abrasion resistance-imparting materials, e.g., natural waxes such as carnauba wax, beeswax and haze wax; synthetic waxes such as polyethylene wax, montan wax, paraffin wax, zinc stearyl ketone and microcrystalline wax; and stearic acid and various stearic acid-based metal soaps such as aluminum stearate, magnesium stearate and calcium stearate. These lubricants may be used in combination of any two or more thereof.

Examples of the filler may include talc, mica, kaolin clay, bentonite, various metal salts of N-ε-lauroyl lysine and N-lauroyl-β-alanine, calcium carbonate, magnesium carbonate, magnesium sulfate, boron nitride, potassium titanate whisker, calcium carbonate whisker, titanium dioxide whisker, magnesium sulfate whisker, calcium sulfate whisker and aluminum sulfate whisker. These fillers may be used in combination of any two or more thereof.

Meanwhile, amine-based compounds tend to be reacted with the fullerenes to form polymers thereof, resulting in deteriorated lubricating property of the fullerenes. In addition to the above components, any suitable solvent may be used upon molding.

When it is required to dry the molded product under heating to remove the binder or solvent therefrom, the drying under heating may be conducted at such a temperature that the fullerenes are free from reaction thereof and, therefore, the fullerene skeleton thereof suffers from no breakage. For example, under a vacuum condition, the heat-drying temperature is usually not higher than 200° C. More specifically, when the molded product is heated at a high temperature in an oxygen-containing atmosphere, the fullerenes tend to be oxidized. Also, when the molded product is heated at a high temperature such as not lower than 700° C., the fullerenes tend to be reacted with each other even under an inert atmosphere to form polymers thereof, resulting in deteriorated properties of the fullerenes such as poor lubricating property.

The film-forming product of the present invention is in the form of a molded product and, therefore, can be readily handled as compared to those products in the form of particles or a dispersion. Further, the film-forming procedure can be performed only by such an easy work of rubbing a surface of an object with the film-forming product.

Next, the method of using the film-forming product of the present invention, i.e., the film-forming method according to the present invention, is described. The film-forming method of the present invention is characterized by rubbing a surface of an object with the film-forming product of the present invention to attach it thereon. Therefore, the “film” formed by the method of the present invention means, for example, a “coating film” for protecting a surface of the object. Since the fullerenes are in the form of a fine molecular crystal, fine irregularities being present on the surface of the object can be filled therewith. In addition, the thus formed coating film tends to be hardly removed (hardly wiped off). Also, the fullerenes contain a five-membered ring within a molecule thereof and, therefore, exhibit a high reactivity. Therefore, under a high temperature such as not lower than 200° C., the fullerenes tend to be reacted with a surface of an object made of metals, etc., or tends to be reacted with each other to form a rigid film such as an amorphous carbon film, so that the resultant film is more hardly peeled off from the surface of the object. As a result, it is considered that the obtained film can also be further improved in durability. In addition, the fullerenes are in the form of a molecule constituted from carbon atoms only and, therefore, have advantages such as a less amount of heat-decomposed gases generated under a high temperature condition as compared to other organic substances.

On the other hand, graphite ordinarily used as a mold release agent is in the form of a layered crystal having a cleavage property and, therefore, exhibits no plastic deformation property. For this reason, when rubbing a surface of an object with graphite to attach it thereon, the graphite is simply placed on the surface of the object and may fail to be filled into irregularities present thereon only by such a rubbing procedure, resulting in poor adhesion thereto. Further, the graphite is very stable and has no reactivity, so that a film produced therefrom tends to be readily peeled off from the surface of the object.

As is apparent from the above descriptions, in the case where the film-forming product of the present invention is used to form a mold releasing film on a surface of a metal mold, it is considered that the obtained film becomes more rigid owing to frictional heat generated upon molding, resulting in excellent mold releasing effect. In particular, when the metal mold is heated, or when a material to be molded within the metal mold has a high temperature and the metal mold temperature is about 200 to 500° C., the mold releasing effect can be further enhanced. Further, in the case where the film-forming product of the present invention is used to form a solid lubricating film, it is considered that the film becomes more rigid owing to frictional heat generated upon lubricating. As a result, it is expected the same high effect as that of the above mold releasing film can be exhibited.

The object to be treated by the film-forming method of the present invention may be selected from various products depending upon the method of using the film-forming product. For example, the film-forming method of the present invention may be applied to the case where a mold releasing film is formed on a surface of a metal mold upon molding metals, plastics or ceramics (applications as mold release agent), the case where a lubricating film is formed on a sliding surface of a slide member made of the same materials as described above (applications as solid lubricant), etc.

In particular, examples of the suitable applications as mold release agent may include powder metallurgy of iron, copper, stainless steel, non-ferrous metals, etc.; plastic working such as forging, rolling, pressing and drawing of steel, stainless steel, titanium, etc. at hot, warm and cold stages; die casting of aluminum, magnesium, zinc alloys, copper alloys, etc.; casting such as metal mold casting and low-pressure casting; injection-molding and compression-molding of various plastics, or the like. Among these applications, more preferred is the die casting performed at a metal mold temperature of 200 to 500° C. Also, in the applications as solid lubricant, although the film made of fullerene as a single substance can exhibit a good lubricating property, a lubrication oil may be further applied on a surface of the thus formed solid lubricating film. In this case, it is expected that the film containing fullerenes as a main component which is produced according to the method of the present invention can exhibit not only an effect of improving a lubricating property of the lubricating oil but also such a deterioration-preventing effect owing to trapping radicals contained in the lubricating oil.

In addition, a thin film of the fullerenes has a blackish brown color. Therefore, in view of the color of the fullerene film, it is considered that the film-forming product of the present invention is used in applications such as colorants, writing utensils and cosmetics as well as mending materials.

The thickness of the film formed according to the film-forming method of the present invention may be appropriately determined depending upon the applications thereof, and is generally in the range of from several hundred nanometers to several hundred micrometers. The size (adhesion area) of the film is not particularly limited as long as the excellent effects of the present invention can be attained. For example, when used as a mold release agent, it is preferred that the film is uniformly formed over a whole area of a contact surface with a mold. Further, the film may be locally formed on specific portions of a metal mold or a lubricated slide member for the anti-seizing purpose.

Next, the mold release agent of the present invention is described. The mold release agent of the present invention is characterized by containing fullerenes. The “mold release agent” used herein means those used for separating a metal mold and a molded product from each other, and includes such a concept covering a mold coating agent applied to a metal mold. The configuration of the mold release agent is not particularly limited, and may be, for example, in the form of a powder agent or a dispersion in liquid (such as water and an organic solvent). However, from the standpoint of simple and facilitated application onto a surface of an object, the mold release agent is preferably in the form of the above molded product.

The mold release agent in the form of the powder agent may be directly sprinkled over the metal mold, whereas the mold release agent in the form of the dispersion may be sprayed over the metal mold using a sprayer or applied thereover by brushing. Further, the fullerene film may also be formed on the surface of the metal mold by a vacuum vapor deposition method.

### EXAMPLES

The present invention is described in more detail by Examples, but the Examples are only illustrative and not intended to limit the scope of the present invention.

### Example 1

### Production of Film-Forming Product

As the molding raw material, there was used only a mixture of fullerenes composed of 61% by weight of C₆₀, 25% by weight of C₇₀ and 14% by weight of other fullerenes having higher molecular weights without adding any molding assistants thereto. Using a pressure-molding machine, the molding raw material was molded into a bar-shaped product having a length of 5 mm, a width of 5 mm and a height of 30 mm, thereby producing a film-forming product. The molding conditions were as follows: molding atmosphere: air; molding temperature: ordinary temperature; molding pressure: 350 kg/cm²; pressing time: 3 min.

### Mold Releasability Test

A powder of partially stabilized zirconia (97 mol % of ZrO₂ and 3 mol % of Y₂O₃) was compression-molded under a pressure of 1850 kg/cm² to form a cylindrical molded product having a diameter of 1 cm and a height of 1 cm. Upon the molding, the above-produced film-forming product was rubbed by hand over a whole surface of a metal mold (made of an alloy tool steel “SKD11”), and an excessive amount of the film-forming product applied was wiped off to form a uniform fullerene film thereon. As a result, it was confirmed that the molded product was taken out of the mold with a very good releasability without adhesion to the mold and breakage thereof. On the other hand, when no fullerene film was formed on the surface of the metal mold, the obtained molded product suffered from adhesion to the metal mold upon taking the molded product out of the metal mold, and it was therefore difficult to release the molded product from the metal mold.

### Example 2

The same procedure as defined in Example 1 was conducted except that an alumina powder was molded in the mold releasability test. It was confirmed that in the mold releasability test, the molded product was taken out of the mold with a very good releasability without adhesion to the mold and breakage thereof. On the other hand, when no fullerene film was formed on the surface of the metal mold, the molded product suffered from adhesion to the metal mold upon taking the molded product out of the metal mold, and it was therefore difficult to release the molded product from the metal mold.

### Comparative Example 1

The same procedure as defined in Example 1 was conducted except that a graphite powder was used as the molding raw material upon forming the film-forming product. However, the graphite powder as the raw material was deteriorated in moldability and, therefore, failed to provide a suitable molded product. Further, the same procedure as described above was conducted except for using a molding raw material made of a graphite powder containing 10% by weight of polyvinyl alcohol as a molding assistant. However, the results was the same as that using the above graphite powder containing no molding assistant.

### Example 3

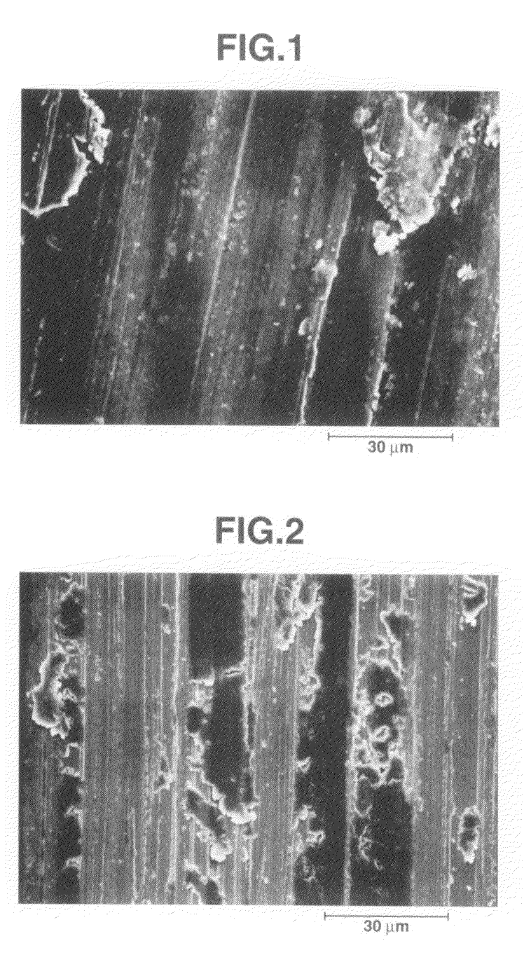

A pencil lead-shaped product having the below-mentioned composition and a diameter of 2 mm which was obtained by an ordinary extrusion-molding method was inserted into a pencil lead holder, thereby obtaining a film-forming product. The thus obtained film-forming product was rubbed over a whole surface of an alloy tool steel (SKD) so as to form a uniform coating film thereon when visually observed. A surface of the resultant coating film was observed by an electron microscope (× 1,000). As a result, it was confirmed that a fullerene film was formed over an entire surface of the SKD as shown in FIG. 1. Specifically, in FIG. 1, abrasion flaws present on the surface of the SKD were covered with the coating film and, therefore, were observed merely vaguely. Meanwhile, island-like portions observed on right and left upper sides of FIG. 1 were such portions where the fullerene film having a large thickness was formed. The difference in tone between portions other than the island-like portions in FIG. 1 was due to the difference in thickness of the coating film formed.

TABLE 1
Composition of a molded product containing
fullerenes

| Components | Content (wt %) |
|---|---|
| Mixed fullerene (produced by | 42 |
| Frontier Carbon Corporation) | |
| Talc | 21 |
| Metal soap | 14 |
| Natural wax | 7 |
| Nitrocellulose | 16 |

### Comparative Example 2

The same procedure as defined in Example 3 was conducted except that a graphite powder was used in place of the mixed fullerene, thereby producing a film-forming product. The thus obtained film-forming product was rubbed over a whole surface of the SKD so as to form a uniform coating film thereon when visually observed. A surface of the coating film was observed by an electron microscope (× 1,000). As a result, it was confirmed that graphite was adhered to the SKD only partially, and many portions of the SKD remained in an uncoated state as shown in FIG. 2. Specifically, in FIG. 2, a plurality of vertically formed island-like portions were such portions where the graphite coating film having a large thickness was formed, whereas portions other than the island-like portions were graphite-uncoated portions. In the graphite-uncoated portions, abrasion flaws present on the surface of the SKD were clearly observed. The area ratio of the graphite-uncoated portions was about 60%.

Meanwhile, the present patent application is based on Japanese Patent Application No. 2004-236715 filed on Aug. 16, 2004, whole contents of which are incorporated herein by reference.

1. A film-forming product comprising a molded product containing fullerenes as a main component.

2. A film-forming product according to claim 1, wherein the product has a bar shape.

3. A film-forming product according to claim 1, wherein the product is used for forming a mold releasing film.

4. A method of forming a film, comprising the step of rubbing a surface of an object with the film-forming product as defined in claim 1.

5. A method according to claim 4, wherein a surface of a metal mold as the object is rubbed with the film-forming product to form a mold releasing film thereon.

6. A mold release agent comprising fullerenes.
